(19) United States
(12) Patent Application Publication
(10) Pub. No.: US 2005/0002284 A1
(43) Pub. Date: Jan. 6, 2005

(54) Optical head device and coil manufacturing apparatus

(76) Inventor: Kazuo Shiba, Suwa-gun (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/846,720

(22) Filed: May 13, 2004

(30) Foreign Application Priority Data
May 21, 2003 (JP) 2003-142862

(51) Int. Cl. G11B 7/00

(52) U.S. Cl. 369/44.14; 369/44.22

(57) ABSTRACT

An optical head device includes a lens holder holding an objective lens and a magnetic drive mechanism for driving the lens holder in a tracking direction and a focusing direction. The magnetic drive mechanism includes a plurality of drive coils mounted on the lens holder and a drive magnet facing the drive coils on a frame. The plurality of drive coils are formed with a continuous coil wire such that a plurality of mid-portions of the continuous coil wire are wound around to form the plurality of drive coils that are electrically connected in series. A coil manufacturing apparatus includes a plurality of winding core parts each of which includes a protrusion part around which the continuous coil wire is wound and a base portion which gives a winding start position for the continuous coil wire. The plurality of winding core parts being constructed such that the respective base portions of the winding core parts are set to be successively higher by a size substantially the same as the thickness of the coils.

### CROSS REFERENCE TO RELATED APPLICATIONS

This application claims priority to Japanese Application No. 2003-142862 filed May 21, 2003, which is incorporated herein by reference.

### FIELD OF THE INVENTION

The present invention relates to an optical head device that is used to record onto or reproduce from an optical recording medium such as a CD (compact disk) and a DVD (digital versatile disk) and to a coil manufacturing apparatus, which is suitable for manufacturing coils for an optical head device or the like.

### BACKGROUND OF THE INVENTION

An optical head device that is used to record onto or reproduce from an optical recording medium such as a CD and a DVD is provided with a lens holder which holds an objective lens for converging a light beam emitted from a light source to an optical recording medium, a holder support member which movably supports the lens holder in a tracking direction and a focusing direction, a magnetic drive mechanism for driving the lens holder, and a frame on which the lens holder is carried through the holder support member. The magnetic drive mechanism includes a plurality of drive coils mounted on the lens holder and drive magnets mounted on the frame.

One of the conventional manufacturing methods for such optical head device is that coil wires are separately wound around on the predetermined portions of the lens holder to form a plurality of drive coils where the winding start portion and the winding end portion of the respective drive coils are connected in a prescribed manner on the lens holder. Another conventional manufacturing method is that drive coils manufactured beforehand are adhesively fixed on the predetermined portions of the lens holder and then the winding start portion and the winding end portion of the respective drive coils are connected in a prescribed manner on the lens holder.

However, both the conventional methods require the drive coils to connect to one another on the small lens holder and thus much labor is required in assembling operations. Further, in order to connect the drive coils to one another, the removal of the insulation coating of a coil wire is required for performing the work of soldering and thus the connecting work in itself requires much labor. Moreover, when a plurality of drive magnets are used, the winding directions of the coil wires are required to be reversed to match the magnetic pole of the drive magnet. The changing of the directions of the winding for every drive coil is also problematic and is labor intensive work.

In order to solve such problems, a construction has been proposed to wind a coil wire to form the character “8” so as to form two drive coils at the same time that are electrically connected to each other (see, for example, Japanese Patent Laid-Open No. Hei 8-171732).

However, in the construction where two drive coils are formed in an integral manner by winding a coil wire so as to form the character “8”, the coil wire passes between the drive coils many times and thus increases the electric resistance and the weight of the drive coils.

### SUMMARY OF THE INVENTION

In view of the problems described above, it is an object and advantage of the present invention to provide an optical head device in which a plurality of drive coils can be electrically connected in series easily and the respective winding directions of the plurality of drive coils can be freely set without increasing the electrical resistance and the weight of the drive coils.

Further, it is another object and advantage of the present invention to provide a coil manufacturing apparatus capable of efficiently manufacturing a plurality of coils that are electrically connected in series.

In order to achieve the above object and advantage, according to an embodiment of the present invention, there is provided an optical head device including an objective lens for converging a light beam emitted from a light source to an optical recording medium, a lens holder which holds the objective lens, a holder support member which movably supports the lens holder in a tracking direction and a focusing direction, a magnetic drive mechanism for driving the lens holder in the tracking direction and the focusing direction, a frame on which the lens holder is mounted via the holder support member. The magnetic drive mechanism includes a plurality of drive coils mounted on one of the lens holder and the frame and a drive magnet facing the drive coils on the other of the lens holder and the frame. The plurality of drive coils are formed with a continuous coil wire such that a plurality of mid-portions of the continuous coil wire are wound around to form the plurality of drive coils which are electrically connected in series.

According to the embodiment of the present invention, since the plurality of drive coils are formed with a piece of continuous coil wire, the drive coils can be electrically connected in series even though the connecting operations between the drive coils are not performed. Further, since the drive coils are electrically connected with the continuous coil wire, their electrical resistances and weights do not increase. Furthermore, when the drive coils are successively formed by winding the coil wire, the winding directions of the plurality of drive coils connected to one another with one piece of the continuous coil wire can be freely set only by changing the winding direction. Moreover, since the connecting operations between the drive coils are not performed, the disconnection of the wire due to working defects does not occur. In addition, the length of the interconnecting portions between the drive coils which are connected to one another with one piece of the coil wire can be arbitrarily set only by changing the distance between the drive coils.

In accordance with an embodiment of the present invention, the plurality of drive coils include a plurality of coil pairs, each of the coil pairs further including a first drive coil in which the continuous coil wire is wound in one direction and a second drive coil in which the continuous coil wire is wound in the other direction. The first drive coil and the second drive coil are adjacently disposed such that the side portion of the first drive coil and the side portion of the second drive coil through which an electric current flows in the same direction are adjacently disposed, and the drive magnet faces both side portions of the first drive coil and the second drive coil.

In accordance with an embodiment of the present invention, the drive coils are, for example, tracking drive coils for the optical head device. The tracking drive coils may be mounted on the frame side. However, in this case, the drive magnet is required to be mounted on the lens holder. Therefore, the weight of the lens holder can be reduced by mounting the tracking drive coils on the lens holder compared in the case that the drive magnet is mounted on the lens holder. In this case, it is preferable that four tracking drive coils and respective portions connecting four tracking drive coils are adhesively fixed on the outer peripheral face side of the lens holder.

In accordance with an embodiment of the present invention, it is preferable that both ends of the continuous coil wire are connected to the electrodes of a flexible circuit board that is connected to the lens holder.

In accordance with an embodiment of the present invention, it is preferable that the lens holder is provided with a positioning protrusion part which engage with an inner face of the drive coil to position the drive coil.

Also, according to an embodiment of the present invention, there is provided a coil manufacturing apparatus including a continuous coil wire for forming a plurality of coils and a plurality of winding core parts. Each of the winding core parts includes a protrusion part around which the continuous coil wire is wound and a base portion which gives a winding start position for the continuous coil wire. The plurality of winding core parts are constructed such that the respective base portions of the winding core parts are set to be successively higher by a size substantially the same as the thickness of the coils.

According to the embodiment of the present invention, the height positions (winding start position for the continuous coil wire) of the base portions of the winding core parts are set to be successively higher by the amount of the thickness of the respective coils. Therefore, when the coil wire is wound around the base portion of the succeeding winding core part after the coil wire has been wound around the preceding winding core part, the coil wire can be guided at the same height position from the preceding winding core part to the succeeding winding core part. Therefore, the coil wire will not be curled between the coils.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a schematic construction view showing an optical system of an optical head device to which the present invention is applied.

FIG. 2(A) is a plan view showing an objective lens drive mechanism of the optical head device in accordance with an embodiment of the present invention and FIG. 2(B) is its sectional view.

FIG. 3(A) is a plan view showing a lens holder of the objective lens drive mechanism shown in FIG. 2 which is provided with a focusing drive coil and tracking drive coils. FIG. 3(B) is its left side view, FIG. 3(C) is its right side view, FIG. 3(D) is its bottom view and FIG. 3(E) is its front view.

FIG. 4(A) is a plan view schematically showing a coil manufacturing apparatus for manufacturing four tracking drive coils in accordance with an embodiment of the present invention, and FIG. 4(B) is its explanatory front sectional view.

FIG. 5 is a plan view showing a coil manufacturing apparatus for manufacturing four tracking drive coils in accordance with another embodiment of the present invention.

### DETAILED DESCRIPTION OF THE PREFERRED EMBODIMENTS

An optical head device in accordance with an embodiment of the present invention will be described below with reference to the accompanying drawings.

Overall Construction

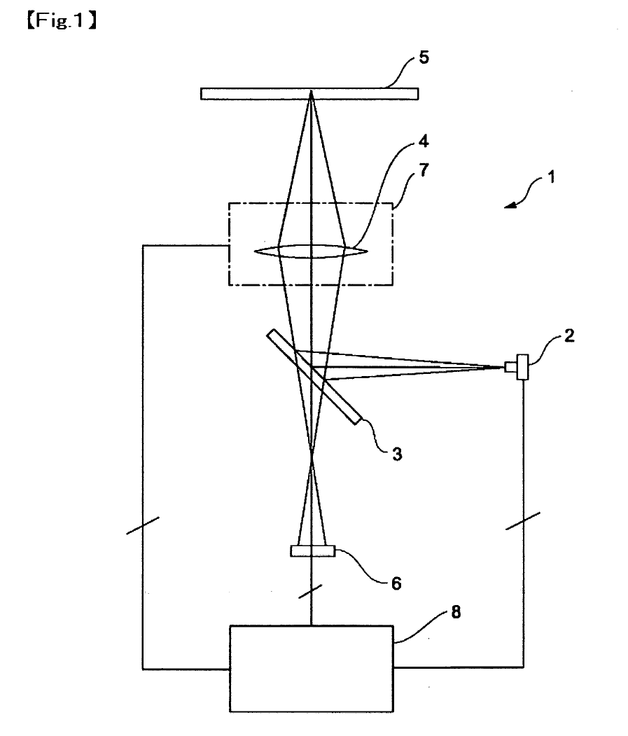

FIG. 1 is a schematic construction view showing an optical system of an optical head device to which the present invention is applied. As shown in the drawing, an optical head device 1 either records information onto or reproduces information from an optical recording disk 5 such as a CD or a DVD (optical recording medium). The optical head device 1 is constructed such that a laser beam emitted from a laser light source 2 is reflected by a half mirror 3 and condensed by an objective lens 4 to focus on the information recording face of the optical recording disk 5. The position of the objective lens 4 in a tracking direction and a focusing direction is servo-controlled by the objective lens drive mechanism 7 of a sliding and rotating type shaft.

The return light reflected by the optical recording disk 5 is incident on a photo detector 6 through the objective lens 4 and the half mirror 3. A drive control device 8 performs an information reproduction processing based on the amount of received light with the photo detector 6 and controls the operation of the objective lens drive mechanism 7 to servo-control the position of the objective lens 4 in the tracking direction and the focusing direction and to control the drive of the laser light source 2.

These constructional elements are mounted on a frame (not shown in the drawings) which is moved in the radial direction of the optical recording disk 5.

Objective Lens Drive Mechanism

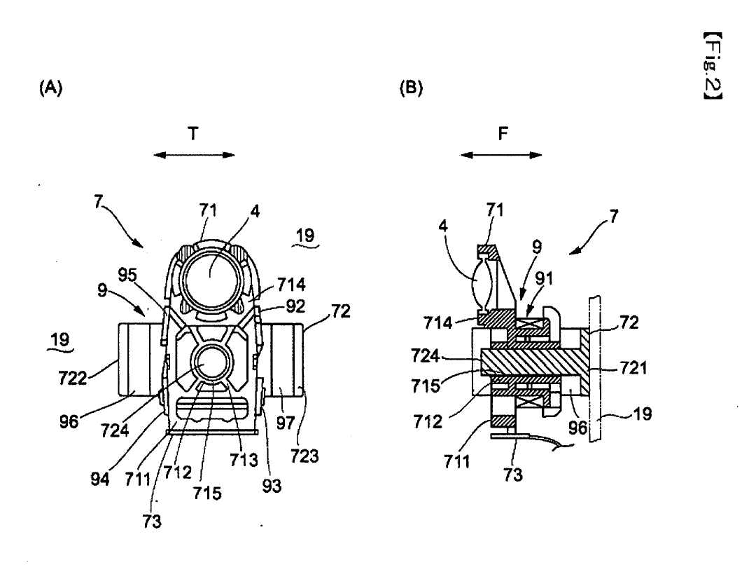

FIG. 2(A) is a plan view showing the objective lens driving mechanism of the optical head device in accordance with an embodiment of the present invention and FIG. 2(B) is its sectional side view.

As shown in FIGS. 2(A) and 2(B), the objective lens drive mechanism 7 includes a lens holder 71 holding the objective lens 4, a holder support member 72 supporting the lens holder 71, a magnetic drive mechanism 9 for driving the lens holder 71 in the tracking direction shown by the arrow “T” and in the focusing direction as shown by the arrow “F”, and a frame 19 on which the lens holder 71 is mounted through the holder support member 72.

The lens holder 71 is provided with a body part 711 formed in a rectangular and tubular shape and a cylindrical bearing part 712 disposed on an inner side of the body part 711. The body part 711 and the bearing part 712 are connected to each other with a plurality of ribs 713. An objective lens mounting part 714 is formed at an end portion of the body part 711 and the objective lens 4 is adhesively fixed on the objective lens mounting part 714. The inner peripheral face of the bearing part 712 is formed as a shaft hole 715.

The holder support member 72 is provided with a rectangular bottom wall part 721 and a pair of outer yokes 722 and 723 which are raised on the right and left sides from an outer peripheral edges of the bottom wall part 721. A support shaft 724 stands straight upward at the center portion of the bottom wall part 721. The holder support member 72 rotatably supports the lens holder 71, of which the shaft hole 715 is inserted on the support shaft 724, in the circumferential direction of the support shaft 724 (tracking direction) as well as in the axial direction (focusing direction) in a slidable manner. The holder support member 72 is mounted on the frame 19 through a tilt angle adjusting mechanism and thus the frame 19 supports the lens holder 71 through the holder support member 72.

The magnetic drive mechanism 9 is provided with a focusing drive coil 91 and four tracking drive coils 92, 93, 94, 95 attached on the side face of the lens holder 71, and drive magnets 96, 97 attached on the holder support member 72 (frame 19 side).

The drive magnets 96, 97 are polarized and magnetized in its thickness direction (tracking direction shown by the arrow “T” in FIG. 2(A)) and respectively attached on the outer yokes 722, 723 of the holder support member 72 such that the same polarity sides (inner side) of the magnets 96, 97 face the lens holder 71.

Construction of Drive Coils

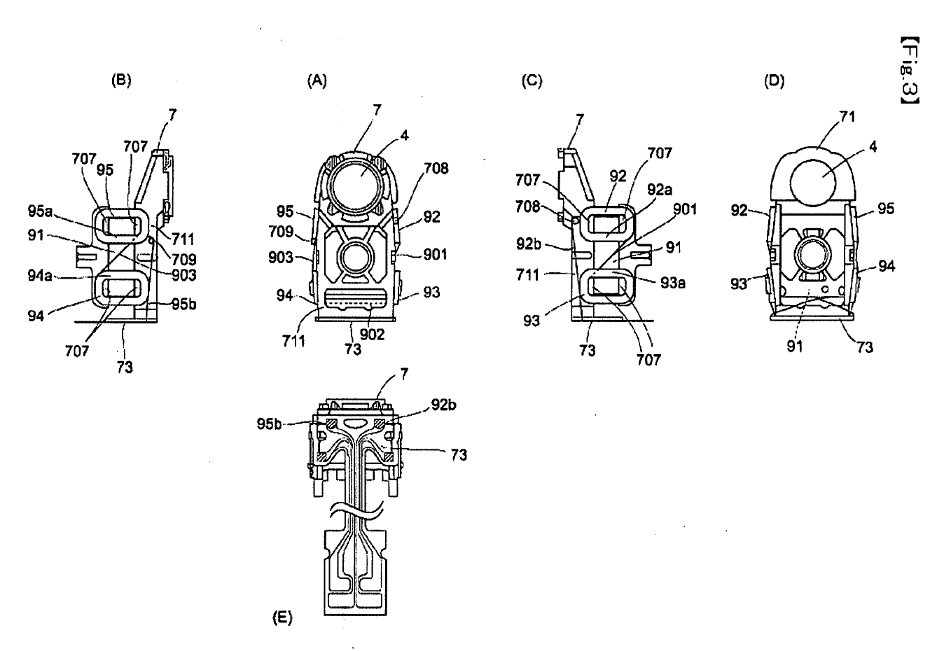

FIG. 3(A) is a plan view showing the lens holder 7 of the objective lens drive mechanism 9 shown in FIG. 2 which is provided with the focusing drive coil 91 and the tracking drive coils 92, 93, 94, 95. FIG. 3(B) is its left side view, FIG. 3(C) is its right side view, FIG. 3(D) is its bottom view and FIG. 3(E) is its front view.

As shown in FIGS. 2 and 3, the focusing drive coil 91 is wound around the body part 711 of the lens holder 71. An electric power is supplied to the focusing drive coil 91 through the terminal ends of the coil wire connected to a flexible circuit board 73 which is attached on an opposite end portion of the lens holder 71 with respect to the objective lens 4. The tracking drive coils 92, 93, 94 and 95 are formed in a flat shape and adhesively fixed on the focusing drive coil 91 mounted on the body part 711 of the lens holder 71.

As shown in FIG. 2(A), the tracking drive coils 94 and 95 are adjacently disposed on the outer peripheral face on the left side of the lens holder 71 as a pair of tracking drive coils and the drive magnet 96 is disposed at a position such that the drive magnet 96 faces both the adjacent side portions 94a and 95a of the tracking drive coils 94 and 95. As a result, the adjacent side portions 94a and 95a facing the drive magnet 96 are the effective side portions of the tracking drive coils 94 and 95. The tracking drive coils 92 and 93 are adjacently disposed on the outer peripheral face on the right side (see FIG. 2(A)) of the lens holder 71 as a pair of tracking drive coils and the drive magnet 97 is disposed at a position such that the drive magnet 97 faces both the adjacent side portions 92a and 93a of the tracking drive coils 92 and 93. As a result, the adjacent side portions 92a and 93a facing the drive magnet 97 are the effective side portions of the tracking drive coils 92 and 93.

The tracking drive coils 92, 93, 94 and 95 are required to be electrically connected in series. Further, the directions of an electric current passing through the effective side portions 92a and 93a are required to be the same and the directions of an electric current passing through the effective side portions 94a and 95a are also required to be the same.

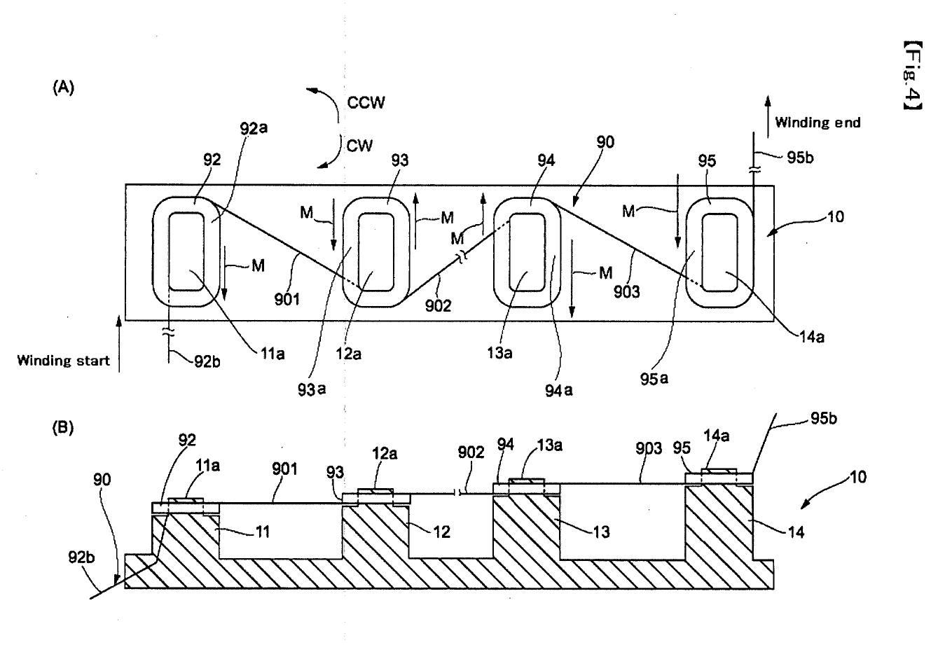

For this reason, in the embodiment of the present invention, a coil assembled body is used which is constructed such that four mid-portions of a continuous coil wire are respectively wound around in a prescribed direction (clockwise direction CW or counterclockwise direction CCW) to form four drive coils 92, 93, 94 and 95 as described below with reference to FIG. 4. Therefore, in the embodiment of the present invention, the connecting portions 901, 902 and 903 formed by using one piece of the coil wire are formed between the tracking drive coils 92 and 93, between the tracking drive coils 93 and 94, and between the tracking drive coils 94 and 95. Further, only one coil wire is successively wound around to form the tracking drive coils 92, 93, 94 and 95 in this order, and thus the winding start portion 92b is drawn out from the tracking drive coil 92 and the winding end portion 95b is drawn out from the tracking drive coil 95.

In the coil assembled body as constructed above, a center hole portion which is formed at the time when the coil wire is wound around is formed in the respective drive coils 92, 93, 94 and 95. On the other hand, as shown in FIGS. 3(B) and 3(C), a pair of positioning protrusion parts 707 which engage with the inner faces of the center hole portion of each drive coil to position the respective drive coils 92, 93, 94 and 95 are formed on the outer peripheral face of the lens holder 71. Therefore, the positioning protrusion parts 707 are fitted into the center hole portion of each of the drive coils and the drive coils 92, 93, 94 and 95 are respectively fixed by using an adhesive in a predetermined position. In the embodiment of the present invention, the focusing drive coil 91 is disposed on the inner side of the tracking drive coils 92, 93, 94 and 95, and thus the inner faces of two positioning protrusion parts 707 may be used as the positioning guide for the focusing drive coil 91.

When the tracking drive coils 92, 93, 94 and 95 are fixed with the adhesive on the lens holder 71, the connecting portions 901, 902 and 903 are also fixed with the adhesive on the outer face of the focusing drive coil 91.

Further, small projecting parts 708 and 709 are formed on the outer peripheral face of the lens holder 71 as shown in FIGS. 3(B) and 3(C). The winding start portion 92b of the tracking drive coil 92 is hooked on the small projecting part 708 and then drawn out to the end portion of the lens holder 71 to electrically connected with the electrode of a flexible circuit board 73 by using a solder. Similarly, the winding end portion 95b of the tracking drive coil 95 is hooked on the small projecting part 709 and then drawn out to the end portion of the lens holder 71 to electrically connected with the electrode of the flexible circuit board 73 by using a solder. Therefore, the soldered electrodes of the flexible circuit board 73 are required only two positions for four tracking drive coils 92, 93, 94 and 95.

Manufacturing Method for Tracking Drive Coil

FIG. 4(A) is a plan view schematically showing a coil manufacturing apparatus for manufacturing four tracking drive coils 92, 93, 94 and 95 in accordance with an embodiment of the present invention, and FIG. 4(B) is its explanatory front sectional view.

In the embodiment of the present invention, a coil manufacturing apparatus 10 as shown in FIGS. 4(A) and 4(B) is used to manufacture four tracking drive coils 92, 93, 94 and 95 by using one piece of coil wire.

The coil manufacturing apparatus 10 includes winding pedestals 11, 12, 13 and 14 with winding core parts 11a, 12a, 13a and 14a for winding the tracking drive coils 92, 93, 94 and 95, and a winding device (not shown) for winding a coil wire 90 successively around the respective winding core parts 11a, 12a, 13a and 14a on the winding pedestals 11, 12, 13 and 14 in this order.

The distances between the respective winding core parts 11a, 12a, 13a and 14a are set such that the connecting portions 901, 902 and 903 of a predetermined dimension are formed when the coil wire 90 is successively wound around according to the following procedures described below.

The coil wire 90 is set to start to be wound around from the base portion side (bottom side in FIG. 4(B)) of the winding core parts 11a, 12a, 13a and 14a. In the embodiment of the present invention, the height positions of the base portions of the winding core parts 12a, 13a and 14a, that is, the upper faces of the winding pedestals 12, 13 and 14 are set to be successively higher by the amount of the thickness of the respective tracking drive coils 92, 93 and 94.

The tracking drive coils 92, 93, 94 and 95 are manufactured by using the coil manufacturing apparatus 10 as constructed above. First, after having reserved the winding start portion 92b with a predetermined length, the coil wire 90 is wound around the winding core part 11a in the clockwise direction CW in FIG. 4(A) to form the tracking drive coil 92.

Next, the coil wire 90 is obliquely guided from the winding core part 11a to the winding core part 12a and then the coil wire 90 is wound around the winding core part 12a in the counterclockwise direction CCW to form the tracking drive coil 93 such that the direction of the electric current flowing through the effective side portion 92a of the drive coil 92 is the same as that of the electric current flowing through the effective side portion 93a of the drive coil 93.

Next, the coil wire 90 is obliquely guided from the winding core part 12a to the winding core part 13a and then the coil wire 90 is wound around the winding core part 13a in the clockwise direction CW to form the tracking drive coil 94.

Next, the coil wire 90 is obliquely guided from the winding core part 13a to the winding core part 14a and then the coil wire 90 is wound around the winding core part 14a in the counterclockwise direction CCW to form the tracking drive coil 95 such that the direction of the electric current flowing through the effective side portion 94a of the drive coil 94 is the same as that of the electric current flowing through the effective side portion 95a of the drive coil 95. Then, the winding end portion 95b with a predetermined length is reserved.

As a result, the connecting portions 901, 902 and 903 are formed between the respective tracking drive coils 92, 93, 94 and 95, and at the same time the respective tracking drive coils 92, 93, 94 and 95 are electrically connected through the connecting portions 901, 902 and 903.

Accordingly, as described with reference to FIGS. 2 and 3, the tracking drive coil 92 wound in the clockwise direction CW and the tracking drive coil 93 wound in the counterclockwise direction CCW are adjacently disposed on the outer peripheral face of the lens holder 71 so as to form a coil pair. In addition, the tracking drive coil 94 wound in the clockwise direction CW and the tracking drive coil 95 wound in the counterclockwise direction CCW are adjacently disposed on the outer peripheral face of the lens holder 71 so as to form a coil pair. Therefore, the tracking drive coils 92, 93, 94 and 95 are electrically connected in series and thus, when an electric current is applied between the winding start portion 92b and the winding end portion 95b through the flexible circuit board, the electric currents with the same direction (referred to the arrow “M” in FIG. 4(A)) flow the effective side portions 92a, 93a and the effective side portions 94a, 95a.

As described above, in the optical head device 1 of the embodiment of the present invention, four drive coils 92, 93, 94 and 95 are formed with a continuous coil wire 90 and thus the drive coils 92, 93, 94 and 95 can be electrically connected in series one another even if the connection between the drive coils is not performed. Further, since the drive coils 92, 93, 94 and 95 are electrically connected with one piece of the coil wire 90, the electrical resistance and the weight of the drive coils do not increase. Furthermore, the shape of the lens holder 71 can be simplified and thus the disk rotational speed such as six-fold speed and eight-fold speed can be applied.

Also, since the connecting operations between the drive coils 92, 93, 94 and 95 are not required, the disconnection of the wire due to working defects does not occur. Further, when the drive coils are successively formed by winding the coil wire 90, the winding directions of the plurality of drive coils 92, 93, 94 and 95, which are connected together with one piece of the coil wire 90, can be freely set only by changing the winding direction. In addition, the length of the interconnecting portions (connecting portions 901, 902 and 903) between the drive coils 92, 93, 94 and 95, which are connected to one another with one piece of the coil wire 90, can be arbitrarily set by only changing the distance between the drive coils 92, 93, 94 and 95.

Moreover, the positioning protrusion part 707 is formed on the lens holder 71 to fit into the hole formed on the inner side of the respective drive coils 92, 93, 94 and 95 for positioning the drive coils 92, 93, 94 and 95. Therefore, the drive coils 92, 93, 94 and 95 can be disposed at a predetermined position with a high degree of accuracy.

In addition, in the embodiment of the present invention, the height positions of the base portions of the winding core parts 12a, 13a and 14a, that is, the upper faces of the winding pedestals 12, 13 and 14 are set to be successively higher by the amount of the thickness of the respective tracking drive coils 92, 93 and 94. Therefore, when the coil wire 90 is wound around the base portion of the succeeding winding core part after the coil wire 90 has been wound around the preceding winding core part, the coil wire 90 can be horizontally guided at the same height position from the preceding winding core part to the succeeding winding core part. Therefore, the coil wire 90 is not curled between the drive coils 92, 93, 94 and 95. Also, the respective lengths of the connecting portions 901, 902 and 903 between the drive coils 92, 93, 94 and 95 can be easily set by changing the distances of the winding core parts 11a, 12a, 13a and 14a.

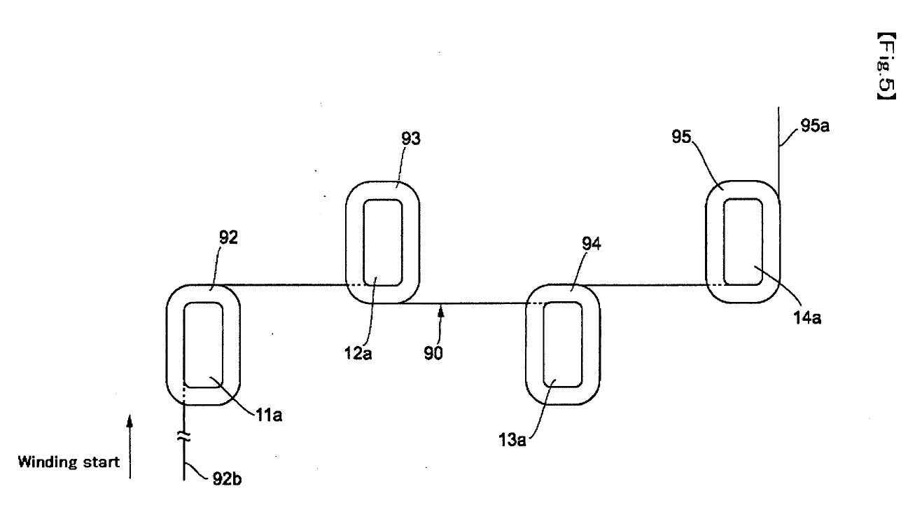

Alternatively, the positions of the winding core parts 11a, 12a, 13a and 14a may be shifted based on the winding direction of the coil wire 90 as shown in FIG. 5. According to the construction described above, the operation of the winding apparatus by which the coil wire 90 is successively wound around the winding core parts 11a, 12a, 13a and 14a can be simplified.

The coil manufacturing apparatuses 10 shown in FIGS. 4 and 5 are suitable for manufacturing the tracking drive coils 92, 93, 94 and 95 of the optical head device 1. However, the coil manufacturing apparatuses 10 may be used to manufacture other types of coils. Further, the coil manufacturing apparatuses 10 shown in FIGS. 4 and 5 may be used to manufacture coils which are not limited to the coils whose winding directions are alternately different from each other. Accordingly, the coil manufacturing apparatuses 10 shown in FIGS. 4 and 5 may be used to manufacture coils whose winding directions are all the same.

The objective lens drive mechanism 7 of the optical head device 1 in the embodiment of the present invention is the lens drive mechanism of a shaft sliding and rotating system in which the lens holder 71 is supported with the support shaft 724. However, the present invention may be applied to the lens drive mechanism of a wire suspension system in which the lens holder is supported with wires.

As described above, in the optical head device in accordance with the embodiment of the present invention, the drive coils can be electrically connected in series even though the connecting operations between the drive coils are not performed since the plurality of drive coils are formed with a piece of continuous coil wire. Further, the drive coils are electrically connected with the continuous coil wire and thus their electrical resistances and weights do not increase. Moreover, since the connecting operations between the drive coils are not performed, the disconnection of the wire due to working defects does not occur. Furthermore, when the drive coils are successively formed by winding the coil wire, the winding directions of the plurality of drive coils, which are connected one another with one piece of the continuous coil wire, can be freely set only by changing the winding direction. In addition, the length of the interconnecting portions between the drive coils can be arbitrarily set only by changing the distance between the drive coils.

Also, in the coil manufacturing apparatus in accordance with the embodiment of the present invention, the height positions of the base portions of the winding core parts are set to be successively higher by the amount of the thickness of the respective coils. Accordingly, when the coil wire is wound around the base portion of the succeeding winding core part after the coil wire has been wound around the preceding winding core part, the coil wire can be guided at the same height position from the preceding winding core part to the succeeding winding core part. Therefore, the coil wire is not curled between the coils.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical head device comprising:
an objective lens for converging a light beam emitted from a light source to an optical recording medium;
a lens holder which holds the objective lens;
a holder support member which movably supports the lens holder in a tracking direction and a focusing direction;
a magnetic drive mechanism for driving the lens holder in the tracking direction and the focusing direction; and
a frame on which the lens holder is mounted via the holder support member;
wherein the magnetic drive mechanism comprises a plurality of drive coils mounted on one of the lens holder and the frame and a drive magnet facing the drive coils on the other of the lens holder and the frame, the plurality of drive coils being formed with a continuous coil wire such that a plurality of mid-portions of the continuous coil wire are wound around to form the plurality of drive coils that are electrically connected in series.

2. The optical head device according to claim 1, wherein the plurality of drive coils comprise a plurality of coil pairs, each of the coil pairs further comprising a first drive coil in which the continuous coil wire is wound in one direction and a second drive coil in which the continuous coil wire is wound in the other direction, the first drive coil and the second drive coil are adjacently disposed such that a side portion of the first drive coil and a side portion of the second drive coil through which an electric current flows in the same direction are adjacently disposed, and the drive magnet faces both the side portion of the first drive coil and the side portion of the second drive coil.

3. The optical head device according to claim 1, wherein the plurality of drive coils are four tracking drive coils mounted on the lens holder for driving the lens holder in the tracking direction and four tracking drive coils and respective connecting portions which connect four tracking drive coils are adhesively fixed on an outer peripheral face side of the lens holder.

4. The optical head device according to claim 3, wherein both ends of the continuous coil wire are connected to electrodes of a flexible circuit board which is connected to the lens holder.

5. The optical head device according to claim 4, wherein only two electrodes of the flexible circuit board are electrically connected with respect to four tracking drive coils.

6. The optical head device according to claim 3, wherein the lens holder is provided with a positioning protrusion part which engages with an inner face of the drive coil to position the drive coil.

7. The optical head device according to claim 6, wherein the lens holder includes a rectangular and tubular body part, a focusing drive coil for driving the lens holder in the focusing direction is wound around the rectangular and tubular body part of the lens holder, and each two tracking drive coils are adhesively fixed on the focusing drive coil on both sides of the rectangular and tubular body part of the lens holder.

8. The optical head device according to claim 7, wherein the focusing drive coil is guided with an inner side of the positioning protrusion part.

9. A coil manufacturing apparatus comprising:
a continuous coil wire for forming a plurality of coils; and
a plurality of winding core parts each of which includes a protrusion part around which the continuous coil wire is wound and a base portion which gives a winding start position for the continuous coil wire;
wherein the plurality of winding core parts being constructed such that the respective base portions of the winding core parts are set to be successively higher by a size substantially the same as a thickness of the coils.

10. An optical head device comprising:
an objective lens for converging a light beam emitted from a light source to an optical recording medium;
a lens holder for holding the objective lens;
a holder support member for movably supporting the lens holder in a tracking direction and a focusing direction; and
a frame for which the lens holder is mounted on by the holder support member;
wherein the magnetic drive mechanism comprises a plurality of drive coils mounted on the lens holder or the frame and a drive magnet facing the drive coils on the other lens holder or the frame which the drive coils are not mounted on, the plurality of drive coils being formed with a continuous coil wire such that a plurality of mid-portions of the continuous coil wire are wound around to form the plurality of drive coils that are electrically connected in series.

11. The optical head device according to claim 10, wherein the plurality of drive coils comprise a plurality of coil pairs, each of the coil pairs further comprising a first drive coil in which the continuous coil wire is wound in one direction and a second drive coil in which the continuous coil wire is wound in the other direction, the first drive coil and the second drive coil are adjacently disposed such that a side portion of the first drive coil and a side portion of the second drive coil through which an electric current flows in the same direction are adjacently disposed, and the drive magnet faces both the side portion of the first drive coil and the side portion of the second drive coil.

12. The optical head device according to claim 10, wherein the plurality of drive coils are four tracking drive coils mounted on the lens holder for driving the lens holder in the tracking direction and four tracking drive coils and respective connecting portions which connect four tracking drive coils are adhesively fixed on an outer peripheral face side of the lens holder.

13. The optical head device according to claim 12, wherein both ends of the continuous coil wire are connected to electrodes of a flexible circuit board which is connected to the lens holder.

14. The optical head device according to claim 13, wherein only two electrodes of the flexible circuit board are electrically connected with respect to four tracking drive coils.

15. The optical head device according to claim 12, wherein the lens holder is provided with a positioning protrusion part which engages with an inner face of the drive coil to position the drive coil.

16. The optical head device according to claim 15, wherein the lens holder includes a rectangular and tubular body part, a focusing drive coil for driving the lens holder in the focusing direction is wound around the rectangular and tubular body part of the lens holder, and each two tracking drive coils are adhesively fixed on the focusing drive coil on both sides of the rectangular and tubular body part of the lens holder.

17. The optical head device according to claim 16, wherein the focusing drive coil is guided with an inner side of the positioning protrusion part.
